(19) United States
(12) Patent Application Publication
(10) Pub. No.: US 2010/0067263 A1
(43) Pub. Date: Mar. 18, 2010

(54) DUAL INTERLEAVED FLYBACK CONVERTER FOR HIGH INPUT VOLTAGE

(75) Inventors: Ting Qian, Warwick, RI (US); Bradley Lehman, Belmont, MA (US)

Correspondence Address: WEINGARTEN, SCHURGIN, GAGNEBIN & LEBOVICI LLP, TEN POST OFFICE SQUARE, BOSTON, MA, 02109, US

(73) Assignee: NORTHEASTERN UNIVERSITY, Boston, MA (US)

(21) Appl. No.: 12/485,540

(22) Filed: Jun. 16, 2009

Related U.S. Application Data
(60) Provisional application No. 61/132,132, filed on Jun. 16, 2008.

(51) Int. Cl. H02M 3/335

(52) U.S. Cl. 363/21.12

(57) ABSTRACT

An integrated magnetic flyback converter includes interleaved phases that can be connected in series for an input stage and in parallel for an output stage. An integrated magnetic core has legs with gaps that may weaken a coupling between a primary and secondary of the associated transformer. The primary and secondary of the transformer may be inversely coupled for each phase. The transformer leg gaps permit each phase to be operated with a duty cycle ratio greater than 50%. The interleaved converter has reduced output current ripple, reduced input component voltage stress, reduced magnetizing inductance, reduced magnetic component physical size and reduced common integrated magnetic core current spikes.

### CROSS REFERENCE TO RELATED APPLICATIONS

This application claims the benefit of U.S. Provisional Application No. 61/132,132, filed Jun. 16, 2008, the entire disclosure of which is hereby incorporated herein by reference.

### STATEMENT REGARDING FEDERALLY SPONSORED RESEARCH OR DEVELOPMENT

This invention was made with government support under Contract No. W911NF-04-2-0033 awarded by the United States Army Laboratory. The government has certain rights in the invention.

### BACKGROUND OF THE INVENTION

The present disclosure relates generally to DC-DC power converters, and relates more particularly to an interleaved flyback DC-DC converter suitable for high input voltage applications.

High density power converters are generally desirable, especially for applications involving modern electronics. Power converters generally include magnetic components such as inductors or transformers, which substantially dictate the physical size of the converter. Integrated magnetic techniques have been used to obtain reduced physical profiles while providing high density power delivery. Typically, the transformers and/or inductors may be combined in a single core to obtain reductions in cost and size of the resulting converters.

Isolated converter topologies that may use integrated magnetics may include buck mode topologies, such as forward, push-pull, half bridge and full bridge arrangements. Another isolated converter topology is a buck boost mode converter, such as a flyback converter. DC-DC power converters often have step down conversions, such as from a 48 volt input to a 1 volt output. These types of step down power conversion applications have been addressed with buck mode isolated topologies, for which integrated magnetic techniques have been developed to help minimize the number of magnetic components and improve the output current ripple cancelation.

In full wave integrated magnetic DC-DC converters, such as push-pull, half bridge and full bridge converters, magnetic integration has been used to provide a single EI or EE core for all of the magnetic components, including an input inductor, a step-down transformer and an output filtering inductor, for example. The primary and secondary windings of the transformer, as well as the inductor windings, are typically wound on the two outer legs of the core. A center leg is provided with a gap, such as an air gap, to permit flux ripple cancellation and a lower core loss in the center leg. A leg generally refers to a magnetic structure in a transformer core that can serve as a flux pathway.

A dual flyback converter may take advantage of a common core with multiple flyback circuits. Flyback converters are often used for low power applications because of their simplicity and lower cost. For example, a flyback converter is often used in AC-DC conversion, such as for stepping down a 400 volt input to a relatively low voltage output such as 24 volts. A flyback converter with multiple flyback circuits typically has the flyback circuits in cascade, sometimes with an interposed power factor correction circuit, and may operate at a power level of about 150 W or less.

Referring to FIG. 1, a known full wave buck boost flyback power converter 100, implemented using a common core 110, is illustrated. Converter 100 is implemented as dual flyback converters that both use core 110 of a transformer T0 to integrate dual flyback transformers 112, 114. Transformers 112, 114 are coupled with a low reluctance in the outer legs of core 110. The relatively higher reluctance magnetic property of an inductor L is integrated into the magnetic structure center leg 116. Center leg 116 includes a gap 118 to produce a relatively higher reluctance coupling in the center leg.

Converter 100 is configured for full wave operation, and causes a respective transformer 112, 114 to store energy when an associated switch SP1, SP2 is turned on. When switch SP1 or switch SP2 turns off, respective transformer 112, 114 releases energy to the load, represented by resistor Ro. Switches SP1 and SP2 are operated to avoid simultaneous conduction that would cause the primary side of transformers 112, 114 to be shorted together. Accordingly, the duty ratio of converter 100, that is the interval of time in a cycle period that a given switch is on, is less than 50%. Such a configuration avoids conduction overlap for switches SP1, SP2, providing a certain amount of dead time between conduction intervals.

### BRIEF SUMMARY OF THE INVENTION

In accordance with the present disclosure, a flyback converter is provided which can have multiple interleaved flyback converters with flyback transformers integrated with a common magnetic core. The flyback converters connected in series on a primary side and in parallel on a secondary side of the flyback transformers. The legs of the flyback transformers can be provided with a gap, such as an air gap, while being formed as part of an integrated magnetic structure. The windings of the primary and secondary sides of the flyback transformers can be inversely coupled. The flyback circuits can be interleaved, which produces a number of advantages in conjunction with the arrangement of the flyback transformers. For example, current ripple is reduced, primary side components experience reduced voltage stresses, magnetizing inductance can be reduced, the physical size of the magnetic components can be reduced and current spikes induced in the common integrated magnetic structure are reduced by providing gaps in the legs of the magnetic core. The interleaved flyback converter can be operated with a duty cycle that is greater than 50% and is suitable for high input voltage applications.

According to an exemplary embodiment of the present disclosure, a dual interleaved flyback converter is provided. The interleaved flyback converter has two phases, or two interleaved flyback converters. The transformer core, which serves as a common core for the two different flyback converters, has three legs, each with a gap. The primary windings of the two flyback converters are arranged in series, while the secondary windings are arranged in parallel. The series arrangement of the primaries permits a reduced voltage stress on the primary side components. The parallel arrangement of the secondary side of the flyback transformers permits a reduced ripple current in the integrated magnetic structure in accordance with interleaved operation. The integrated magnetic core used by both flyback converters permits a reduced physical profile for the magnetic components of the converter, while contributing to current spike suppression. The spacing of the gaps in each leg of the magnetic core is approximately equal, permitting balanced flux to flow through each leg of the transformer core.

According to another exemplary embodiment, an interleaved integrated magnetic converter is provided. The converter includes an integrated magnetic structure with at least two legs that each include a gap. An input stage of the converter has phases that are coupled in series, while a primary and a secondary winding on the integrated magnetic structure are inversely coupled to each other. The converter may also have an output stage with phases that are coupled in parallel.

The presently disclosed topology may be used in various power applications, including industrial/commercial applications. The applications may include such areas as high input voltage converters, consumer electronics such as PCs, PDAs, cell phones and other small profile applications with or without low power or battery power considerations. For example, telecommunication power supplies typically have a 36V-75V input, which is often considered a high voltage input for some of these types of applications. In addition, the disclosed topology may be used in power distribution, such as in the case of computing or househould arrangements with distributed DC power, which may have some advantages over performing AC-DC conversion for each device coupled to input line power.

### BRIEF DESCRIPTION OF THE SEVERAL VIEWS OF THE DRAWINGS

Embodiments of the present disclosure are described in greater detail below, with reference to the accompanying drawings, in which:

FIG. 1. is a circuit diagram of a conventional interleaved flyback converter;

FIG. 2. is a circuit diagram of an interleaved flyback converter in accordance with the present disclosure;

FIG. 3. is a timing diagram illustrating operation of the circuit of FIG. 2;

FIGS. 4a-4d are circuit diagrams illustrating various stages of operation for the interleaved flyback converter for the present disclosure;

FIG. 5. is a magnetic reluctance circuit diagram for the topology illustrated in FIG. 2;

FIG. 6. is a diagram showing flux paths in a transformer core in accordance with the present disclosure;

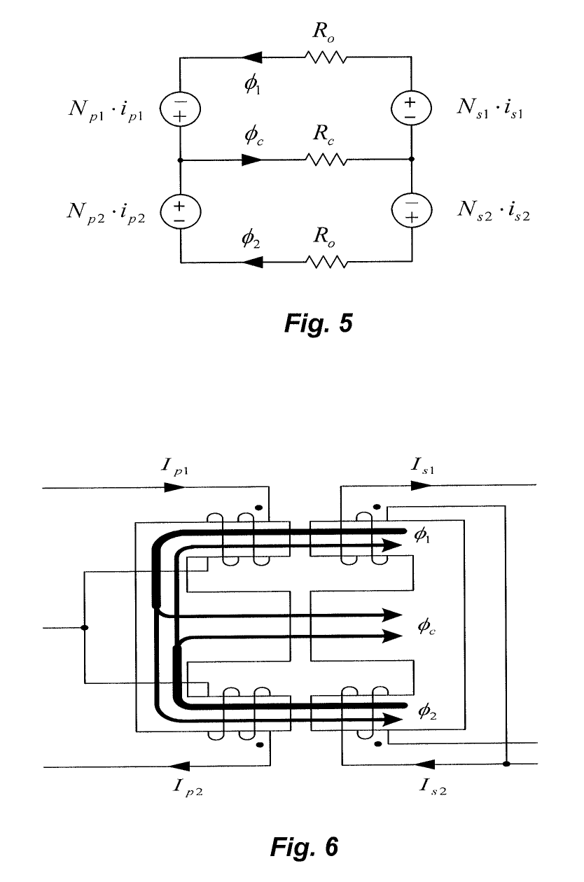

FIGS. 7a-7d are equivalent magnetic reluctance circuit diagrams for the respective operating conditions illustrated in FIGS. 4a-4d;

FIG. 8. is a chart illustrating efficiency versus voltage for an interleaved flyback converter according to the present disclosure; and

FIG. 9 is a partial circuit diagram showing an integrated magnetic structure according to an embodiment of the present disclosure.

### DETAILED DESCRIPTION OF THE INVENTION

The entire disclosure of U.S. Provisional Application No. 61/132,132, filed Jun. 16, 2008, is hereby incorporated herein by reference.

The present disclosure provides an interleaved flyback converter, in which the flyback converter input stages are coupled in series, and the flyback converter output stages are coupled in parallel. Each flyback converter has a switch coupled to a primary winding of a flyback transformer, which switches are respectively turned on and off to produce the interleaved operation of the 2 flyback converters. The flyback transformers are integrated with a common core with gaps between leg core portions that permit a flow of flux. An exemplary transformer core has three legs spanning the primary and the secondary sides, each leg being gapped, such as with an air gap or gap filling that is non-ferromagnetic. The gapping in the transformer legs weakens the coupling between the primary and secondary side of the flyback transformers, which permits the flyback converters to operate independently. The weakened coupling also permits a significant reduction in current ringing caused by a voltage mismatch between the flyback transformer windings. This configuration for an interleaved flyback converter permits the duty ratio for the switches to exceed 50%.

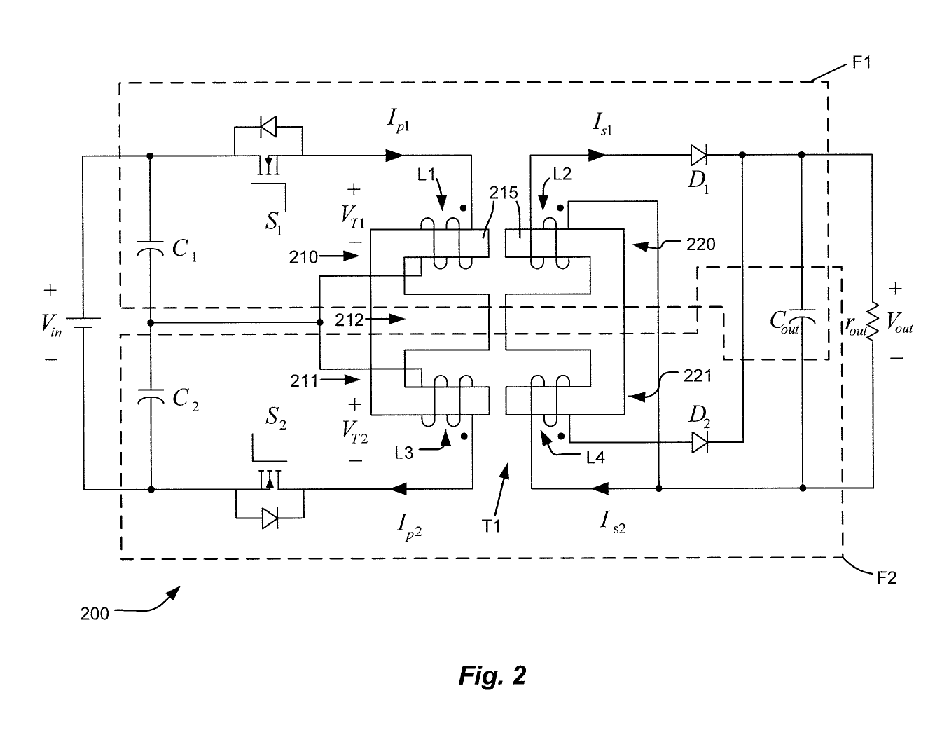

Referring now to FIG. 2, an exemplary embodiment of a dual interleaved flyback converter 200 in accordance with the present disclosure is illustrated. Converter 200 includes two flyback transformers 220, 221 integrated via a common core 215 of a transformer T1. Core 215 thus forms part of an integrated magnetic structure to realize converter 200 in accordance with the present disclosure. Thus, converter 200 can be viewed as an interleaved, integrated magnetic converter.

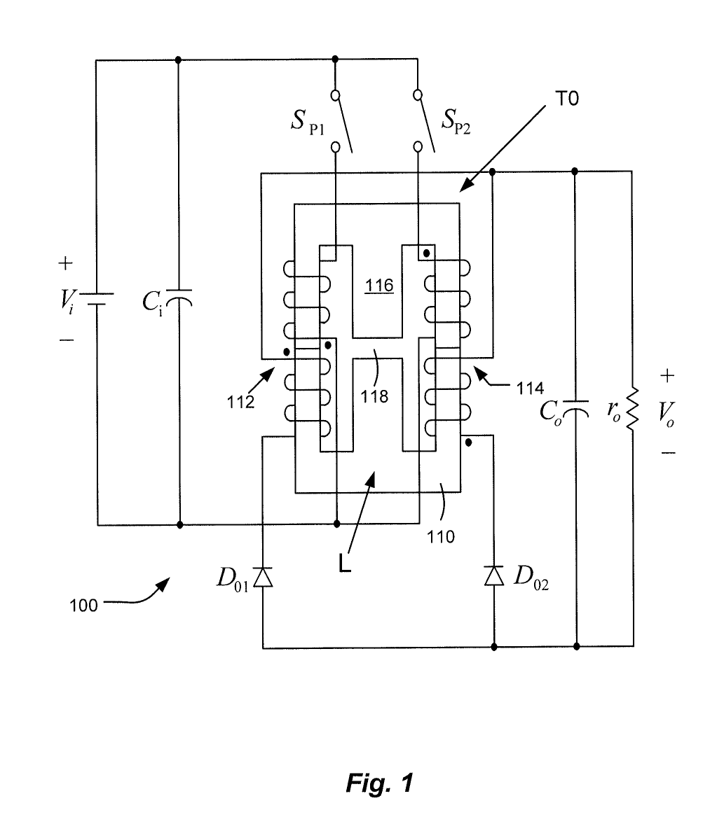

Converter 200 can use two MOSFET switches S1, S2 to control input current and voltage applied to primary windings L1, L3 of transformer T1. Because the primary windings of flyback transformers 220, 221 are coupled in series, each primary switch S1, S2 sees approximately one-half of the input voltage of a corresponding to a single flyback converter. For example, a single flyback converter may have a switch with a voltage rating of about Vin+Vo*Nₚ/Nₛ, where Nₚ and Nₛ are the turn numbers of the primary and secondary windings. Switches S1, S2 may be rated at approximately one-half of such a rating. Accordingly, the voltage stress on switches S1, S2 is reduced to approximately one-half of the voltage stress experienced by traditional full-wave buck boost power converters, such as in converter 100 in FIG. 1. Thus, the rating of switches S1, S2 in converter 200 is approximately half of the corresponding rating of switches SP1, SP2 in converter 100 of FIG. 1.

Converter 200 is implemented with an upper flyback converter F1 and a lower flyback converter F2 shown in dashed lines in the configuration illustrated in FIG. 2. Flyback converter F1 consists of input capacitor C1, switch S1, diode D1, windings L1, L2 in a leg 210 of flyback transformer 220 and output capacitor Cout. Flyback converter F2 consists of input capacitor C2, switch S2, diode D2, windings L3, L4 of a leg 211 of flyback transformer 221 and capacitor Cout. Because the output stages are in parallel, capacitor Cout is shared by flyback converters F1, F2.

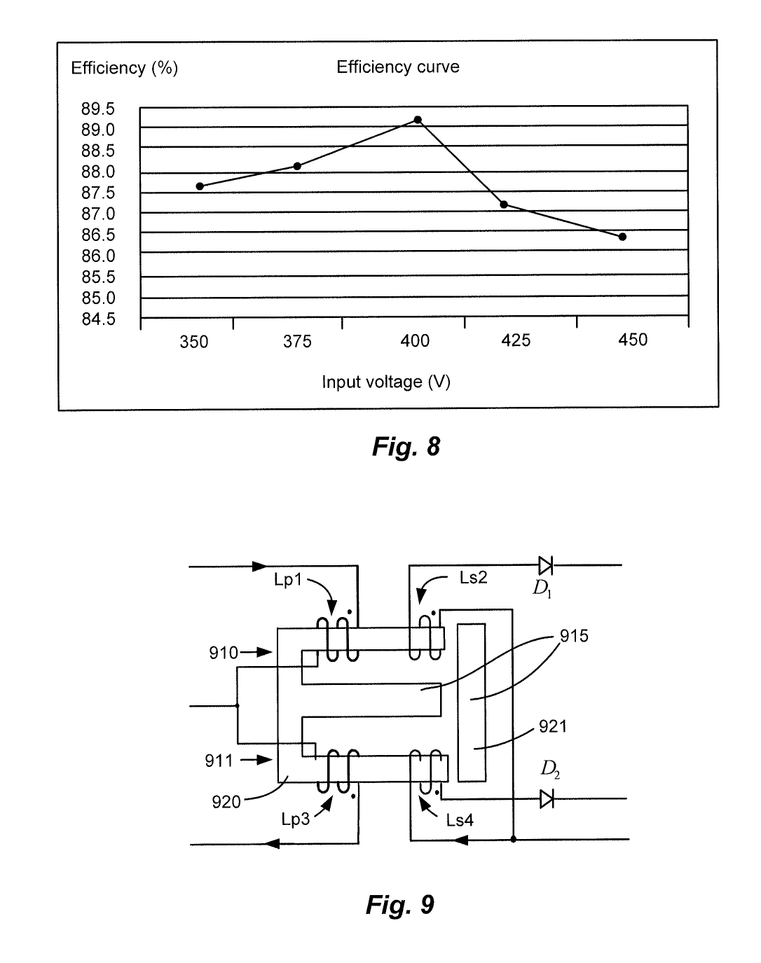

Legs 210, 211 of transformer T1 each have a gap that is of approximately the same dimension. In addition, the gap provided for legs 210, 211 is approximately the same dimension as the gap provided for center leg 212. Legs 210, 211 are implemented as part of core 215 of transformer T1, referred to as an E magnetic core. Referring for a moment to FIG. 9, other types of core structures may be used to implement an integrated magnetic structure, such as a core 915. Core 915 is implemented to include E type core 920 and I type core 921, it being understood that other core types or combinations thereof can be used in accordance with the present disclosure. In addition, it should be understood that the primary windings and secondary windings L1, L2 and L3, L4 shown in FIG. 2 are for illustration purposes, and may not reflect a practical implementation. For example, FIG. 9 illustrates respective primary and secondary windings Lp1, Lp2 and Ls3, Ls4 being implemented as wound around a same physical portion of respective legs 910, 911. Thus, in the example embodiment of FIG. 2, the gaps may be implemented anywhere in legs 210, 211, such as on one side or another of commonly wound windings L1, L2 and L3, L4. Such an implementation may use E or I type core structures, or combinations, as discussed above and exemplified in FIG. 9.

Referring again to FIG. 2, while converter 200 illustrates a dual interleaved flyback converter configuration in accordance with the present disclosure, it should be understood that the concept of the present disclosure is readily extendable to any number of interleaved flyback converters. Accordingly, core 215 may have as many legs as desired for as many interleaved flyback converters as may be implemented. Alternately, or in addition, core 215 of transformer T1 may be provided as a common core for multiple flyback converters so that each of legs 210, 211 may be used in conjunction with additional flyback converters using core 215 as an integrated magnetic core. Furthermore, core 215 may be implemented with an E or I type magnetic structure, or as a combination of these types.

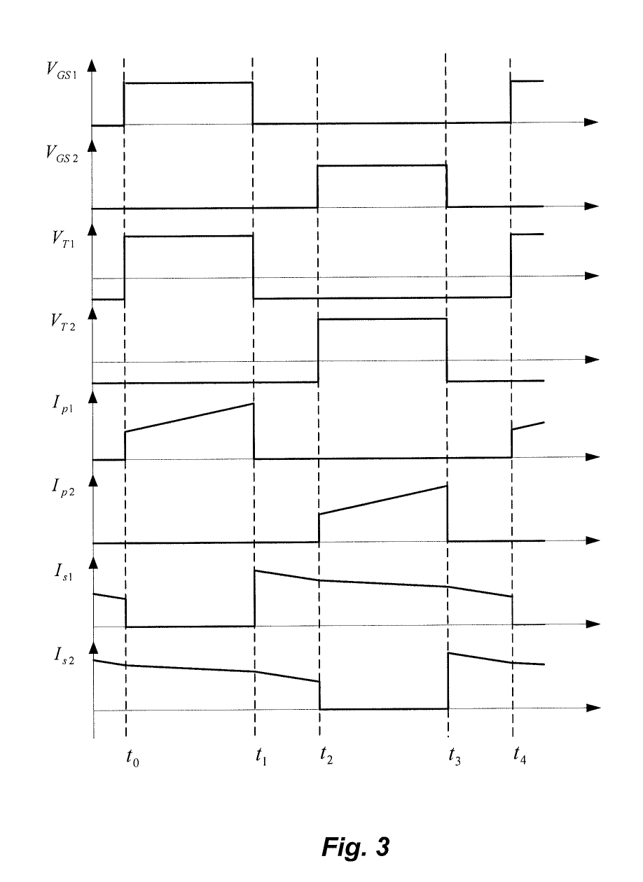

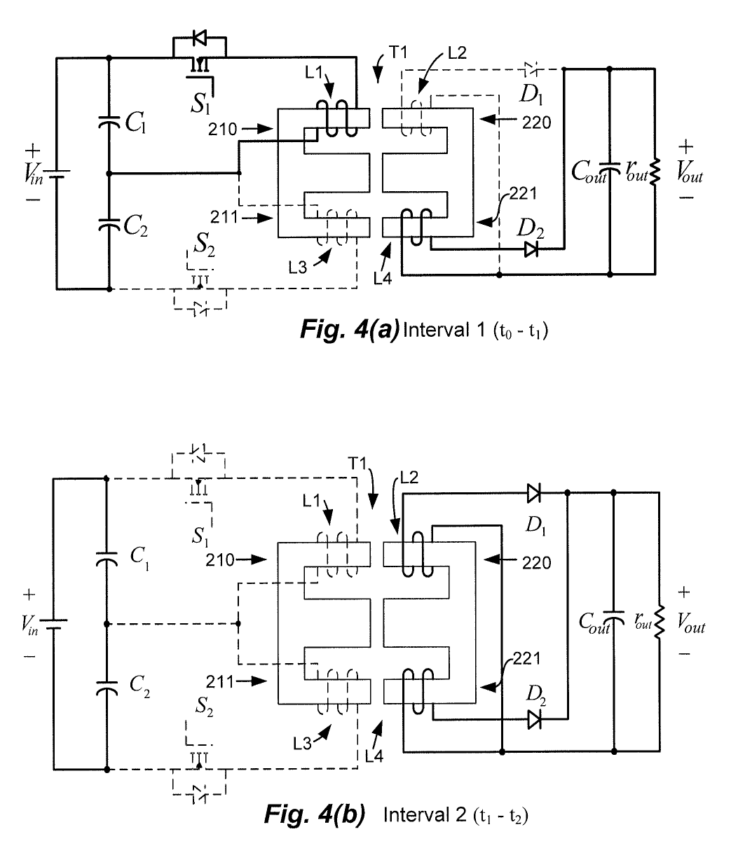

Referring now to FIGS. 3 and 4a-4d, the operation of converter 200 is described in greater detail. FIG. 3 illustrates a duty cycle for converter 200 in the time interval for t0 to t4. Time interval t0-t1 and t2-t3 represent the duty ratio intervals for operation of converter 200. FIG. 4a illustrates the operation of converter 200 during the interval t0-t1. During the interval t0-t1, switch S1 is on and windings L1 and L4 are conducting and carrying current. With switch S1 conducting, flyback converter F1 delivers energy from input capacitor C1 to a primary side of flyback transformer 220 through winding L1. The current through winding L1 increases linearly, as illustrated in FIG. 3 with current Ip1. In this instance, diode D1 of flyback converter F1 is reverse biased and not conducting. In addition, switch S2 of flyback converter F2 is off, or not conducting. Upper flyback converter F1 delivers energy from capacitor C1 to primary winding L1 of flyback transformer 220. A secondary side of flyback transformer 221 conducts current through winding L4 and diode D2, which charges output capacitor Cout. FIG. 3 illustrates current Is2 during the interval t0-t1, which represents the current flowing through diode D2. During the interval t0-t1, the current through winding L4 begins to decrease, and the voltage across winding L4 is output voltage Vout. The voltage across primary winding L2 is equal to the voltage across capacitor C1, which is equal to Vin/2.

During interval t1-t2 illustrated in FIG. 3, flyback converter 200 operates as illustrated in FIG. 4b. In this stage, switches S1 and S2 are turned off, or not conducting. Flyback converters F1 and F2 each release stored energy from respective flyback transformers 220, 221 to output capacitor Cout and the load, represented by resistor Rout. As FIG. 3 illustrates, current Is1 flows through diode D1 and current Is2 flows through diode D2 to supply energy to capacitor Cout. Each of secondary windings L2, L4 have a voltage of Vout during interval t1-t2.

Time integral t2-t3 illustrated in FIG. 3 corresponds to the circuit configuration illustrated in FIG. 4c, which is similar to an inverse of the circuit illustrated in FIG. 4a. As shown in FIG. 4c, switch S1 is off, or not conducting, while switch S2 is on or conducting. The voltage across primary winding L1 is equal to the voltage across capacitor C2, which is equal to Vin/2. Lower flyback converter F2 delivers energy from capacitor C2 to primary winding L3 of flyback transformer 221. The current through primary winding L3 is Ip2, illustrated in FIG. 3 as increasing linearly. Secondary winding L2 continues to conduct current, with diode D1 conducting, providing a current Is1 to charge capacitor Cout. Current Is1 supplied to output capacitor Cout is decreasing during the interval t2-t3. The voltage across secondary winding L2 is output voltage Vout.

During interval t3-t4, circuit operation is as illustrated in FIG. 4d. FIG. 4d illustrates substantially the same operation of converter 200 as is shown in of FIG. 4b. In this instance, both flyback converters F1, F2 release energy through secondary windings L2, L4 during interval t3-t4. The voltage on windings L2, L4 is output voltage Vout, and output capacitor Cout receives the stored energy from windings L2, L4. Current Is1 passing through diode D1 and current Is2 passing through diode D2 are illustrated in FIG. 3 during interval t3-t4 as decreasing at a faster rate than during respective intervals t0-t1 for Is2 and t2-t3 for Is1.

The configuration of flyback converter 200 permits operation, as discussed above, to reduce inductor current ripple. Windings L1-L4 exhibit a coupling inductance in the various operational configurations configured illustrated in FIGS. 4a-4d. Due to the reduction in inductor current ripple, in addition to the coupling inductance, a smaller rating for windings L1-L4 may be used to satisfy current ripple design specifications for a given implementation of flyback converter 200. A smaller inductance is possible for windings L1-L4 in comparison with the windings provided in discrete interleaved flyback converters, such as is illustrated in converter 100 of FIG. 1. Accordingly, converter 200 permits a reduced size for the magnetic components, while maintaining a reduced current ripple and reduced voltage stress on switches S1, S2. Moreover, windings L1 and L2 are inversely coupled, as are windings L3 and L4. In addition, the coupling between windings L1 and L2, and between windings L3 and L4 is not as strong as in conventional converter 100, which has no gap in the discrete flyback transformer legs. With a gap provided for all three legs of transformer T1 in converter 200, a large leakage inductance between the windings of flyback transformers 220, 221 is observed, since the flux generated by each winding in the outer legs 210, 211, can flow through all three legs. In particular, the gap between each of the legs of transformer T1 in converter 200 is approximately the same distance, leading to a somewhat uniform or balanced flux flow in all three legs.

In comparison with the relatively strong coupling provided in the different legs of flyback transformers 112, 114 of conventional converter 100, practical operation considerations illustrate another advantage of converter 200 implemented in accordance with the present disclosure. In high voltage applications, switches S1 and S2, as well as switches Sp1 and Sp2, do not typically operate simultaneously. Because of the non-simultaneous operation, the secondary windings exhibit a voltage mismatch that forms a voltage difference, which is applied to the leakage inductance that exists between the two secondary windings.

Due to gap 118, center leg 116 has a high reluctance while the two outer legs of transformer T0 have relatively low reluctance due to their relatively strong or tight coupling. Because of the different reluctances in the outer and center legs, there is a strong or tight coupling and small leakage inductance in the two secondary windings of transformer T0. Due to non-simultaneous switching of switches Sp1 and Sp2, the voltage mismatch created causes a voltage difference to be applied to the leakage inductance between the two secondary windings. The voltage mismatch between the two secondary windings can lead to high current spikes and resonance in transformer T0.

In the configuration of transformer T1, a gap is provided between legs 210 and 211, and secondary windings L2, L4 are inversely coupled with respective primary windings L1 and L3 with lighter or less tight coupling due to the gaps. The resulting larger leakage inductance between the windings of transformers 220, 221 prevents high current spikes during a voltage mismatch situation. The flux generated by each winding in legs 210, 211 can pass through all three legs 210-212. The gap of legs 210-212 are approximately the same distance dimension. The weakened coupling between the primary and secondary sides of transformers 220, 221 continues to permit current ripple reduction with a suitable coupling design, while also permitting the duty ratio to be greater than 50%.

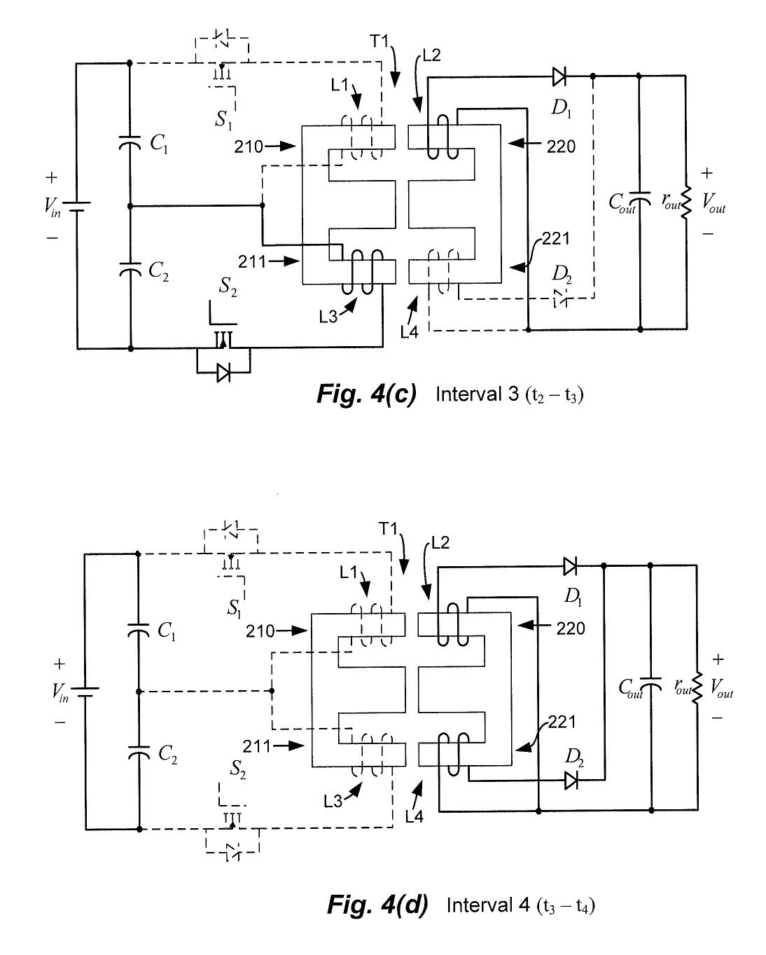

Referring to FIG. 5, an equivalent magnetic reluctance circuit 500 is illustrated for converter 200. Reluctance circuit 500 represent fluxes in each of legs 210-212 of converter 200. The fluxes may be AC or DC, where the peak values of the fluxes are the sum of the DC fluxes and one-half of the AC fluxes. Circuit 500 illustrates the relevant fluxes with the understanding that the conditions of the two outer legs 210-211 are assumed to be symmetrical. Due to the gap existing between all legs, there is no longer a low magnetic reluctance path for the fluxes in center leg 116. The flux generated by each winding in legs 210, 211 can flow through all three legs 210-212. The flux interaction between the windings L1-L4 affects the current ripple and peak values of the flux densities.

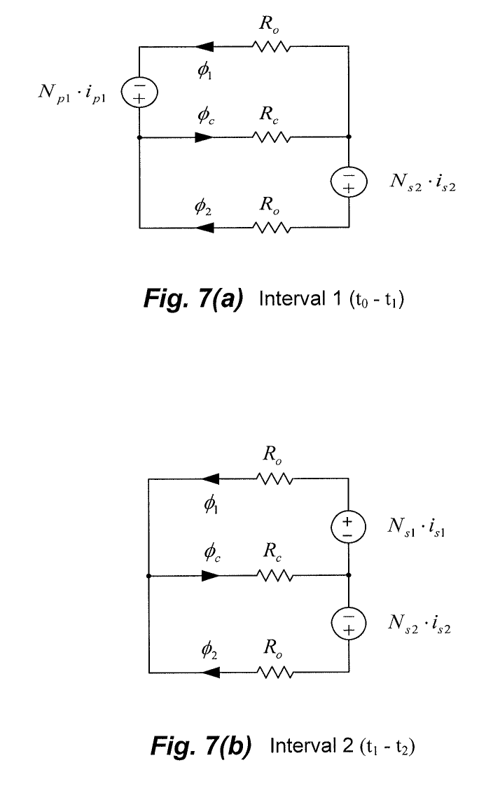

Referring also to FIGS. 7a-7d, equivalent magnetic reluctance circuits corresponding to the operational conditions illustrated in respective FIGS. 4a-4d are shown. The effect of a winding with no current is nil, indicated by the lack of a source compared with FIG. 5. The AC fluxes in outer legs 210, 211 are determined by the time integral of voltages across the windings. Accordingly, the magnitude of the peak-to-peak AC fluxes in outer legs 210, 211 depends on output voltage Vout. Summing the flux rates of outer legs 210, 211 gives the flux rate of center leg 212. The peak values of the fluxes is given by the sum of the DC fluxes and half of the AC fluxes. Saturation of the magnetic core can be avoided by determining the peak value of the flux densities in all three legs 210-212. For a given application or design specification, the current ripple can be calculated together with the peak flux densities to choose or determine a suitable magnetic core size and number of turns for the windings to satisfy current ripple restrictions and magnetic constraints.

In an example dual interleaved flyback converter constructed according to the present disclosure, the components are specified to permit an input voltage of 350-450 V and a 24 V/4 A output, where the switches have a switching frequency of 200 kHz. The switch ratings are chosen to be 500 V, 6 A MOSFET switches, which is approximately one-half the rating for a single flyback or a full wave flyback, such as in converter 100 illustrated in FIG. 1. Diodes D1 and D2 are selected as 100 V/12 A rated diodes. The two coupled flyback transformers are integrated onto a single E-type magnetic core. The gaps provided for each leg of the magnetic core are approximately the same. The primary windings on the transformer have sixty turns while the secondary windings have thirteen turns. The calculated peak values for the flux densities of all three legs are below 2600 Gauss during the entire input voltage variation range at full load.

In operation, the waveforms of the secondary side of the transformer are in phase with the primary side. The rate of change of the secondary current of one flyback converter differs from the other flyback converter operating at different modes. This difference in rate of change for the secondary current is due to the mutual effect between the coupled windings on the secondary side of the transformer. However, each of the flyback converters balances the other during the different modes. Each of the flyback converters shares half of the input voltage in accordance with the series configuration of the input stage. The voltage across the primary winding of the transformer is equal to one-half of the input voltage while the main primary switch is turned on. The primary peak-to-peak current ripple is approximately 0.71 A. Some oscillations in the primary currents causes ringing due to the effect of the leakage inductance between the primary winding and the corresponding secondary winding.

In accordance with an embodiment of the present disclosure, a clamp circuit may be used to reduce the voltage ringing across the switches. Alternately, or in addition, higher voltage rated MOSFETS may be used. Also, or alternately, the coupling between the primary winding and the corresponding secondary winding can be improved, or made stronger, to contribute to suppression of ringing on the primary windings.

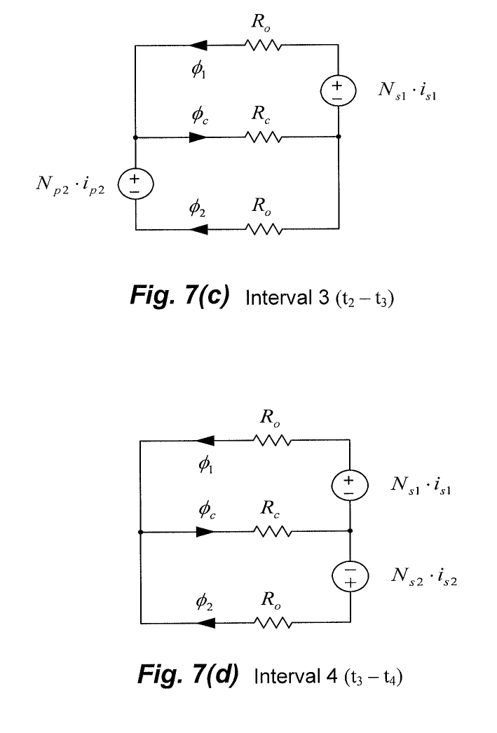

In the example dual interleaved flyback converter, an efficiency of about 89.1 percent with an input of 400 V and an output of 24 V/4 A can be obtained. A graphical illustration of efficiency versus input voltage is provided in FIG. 8 for the exemplary dual interleave flyback converter.

The present disclosure provides a series coupled input and parallel coupled output interleaved flyback converter for high input voltage applications. The connection of the primary side of the interleaved flyback converter in series reduces the voltage stress on the primary components. The legs of the core of the flyback transformer are gapped, while the transformer is integrated into a magnetic core with relatively loose coupling. Current ringing introduced by voltage mismatches between the different flyback converter windings can be suppressed due, in part, to the weakened coupling. The primary and secondary sides of the two transformers are inversely coupled, so that a significant current ripple reduction can be obtained with relatively loose coupling. The magnetic components are reduced in size, while ratings for primary side components can be reduced while maintaining a reduced ripple current and reduced current spike during operation in high voltage applications.

The foregoing description is directed to particular embodiments of this invention. It will be apparent, however, that other variations and modifications may be made to the described embodiments, with the attainment of some or all of their advantages. Therefore, it is the object of the appended claims to cover all such variations and modifications as come within the true spirit and scope of the invention.

What is claimed is:

1. An interleaved flyback converter having at least two phases utilizing a common core of a transformer, comprising:
at least two legs of the core including a gap;
an input stage of the at least two phases being coupled in series; and
an output stage of the at least two phases being coupled in parallel.

2. The converter according to claim 1, further comprising a primary and a secondary winding on the core for each of the at least two phases, the primary and secondary winding being inversely coupled to each other in each of the at least two phases.

3. The converter according to claim 2, wherein the flyback converter is capable of receiving an applied input voltage, and the primary winding for each of the at least two phases being arranged to receive a maximum of about one-half of the input voltage during interleaved operation.

4. The converter according to claim 1, further comprising a diode for each of the at least two phases, each diode including an anode being coupled to a respective output stage, and including a cathode being coupled in common.

5. The converter according to claim 4, further comprising an output capacitor coupled to the cathodes of the diodes.

6. The converter according to claim 2, further comprising an input capacitor being coupled to one of the primary side windings.

7. The converter according to claim 1, wherein the core further comprises at least three legs, each leg including a gap.

8. The converter according to claim 1, wherein the transformer core further comprises an inductance being coupled to each of the at least two phases.

9. The converter according to claim 8, wherein the inductance is arranged to permit reduced current ripple in conjunction with interleaved operation.

10. The converter according to claim 9, wherein the transformer core is arranged in conjunction with the paralleled output stage to permit a reduced inductance value for the inductance.

11. The converter according to claim 1, wherein the core leg gaps are arranged to provide a reduced coupling between the primary and the secondary sides of the transformer such that each of the at least two phases can operate with a duty ratio greater than about 50%.

12. The converter according to claim 1, wherein the core leg gaps are arranged to obtain a relatively large leakage inductance between transformer windings of the at least two phases.

13. The converter according to claim 1, wherein the core leg gaps are arranged to have an approximately equal dimension such that magnetic flux passing through each leg is approximately balanced.

14. The converter according to claim 3, further comprising:
a switch coupled to the primary winding for each of the at least two phases; and
a clamp circuit coupled to each switch for reducing voltage ringing across each switch.

15. The converter according to claim 3, further comprising:
a switch coupled to the primary winding for each of the at least two phases; and
the core leg gaps are arranged to provide an improved coupling between the primary and the secondary windings of the transformer to contribute to suppression of voltage ringing across the switches.

16. A method for implementing an interleaved flyback converter that includes at least two phases and a transformer, comprising:
providing a transformer core having at least two legs that each include a gap;
arranging an input stage of each of the at least two phases to be in series; and
arranging an output stage of each of the at least two phases to be in parallel.

17. The method according to claim 16, further comprising providing an inversely coupled primary and secondary winding on the transformer core for each of the at least two phases.

18. The method according to claim 16, further comprising applying a maximum of about one-half of an input voltage to a primary winding of the transformer during interleaved operation.

19. The method according to claim 16, further comprising:
coupling an anode of a diode to a respective output stage for each of the at least two phases; and
coupling a cathode of the diodes in common.

20. The method according to claim 19, further comprising coupling an output capacitor to the cathodes of the diodes.

21. The method according to claim 18, further comprising coupling an input capacitor to the primary winding.

22. A method for converting power from an input power source using an interleaved flyback converter that includes at least two phases and a transformer, the method comprising:
arranging a transformer core to have at least two legs, each leg corresponding to at least one of the at least two phases and each leg having a gap;
arranging a primary winding and a secondary winding around a leg for each of at least two of the at least two legs;
arranging the primary windings in series;
arranging the secondary windings in parallel; and
alternately switching the input power source to each of the primary windings.

23. The method according to claim 22, further comprising switching the input power source to each of the primary windings with a duty ratio of greater than about 50% for each of the at least two phases.

24. The method according to claim 22, further comprising applying a maximum of about one-half of a voltage from the input power source to each one of the primary windings during interleaved operation.

25. The method according to claim 22, further comprising arranging an associated primary and secondary winding to be inversely coupled.

26. An interleaved integrated magnetic converter having at least two phases, comprising:
an integrated magnetic structure with at least two legs that each include a gap;
an input stage of the at least two phases being coupled in series; and
a primary and a secondary winding on the integrated magnetic structure for each of the at least two phases, the primary and secondary windings being inversely coupled to each other in each of the at least two phases.

27. The converter according to claim 26, further comprising an output stage of the at least two phases being coupled in parallel.

28. The converter according to claim 26, wherein the flyback converter is capable of receiving an applied input voltage, and the primary winding for each of the at least two phases being arranged to receive a maximum of about one-half of the input voltage during interleaved operation.

29. The converter according to claim 27, further comprising a diode for each of the at least two phases, each diode including an anode being coupled to a respective output stage, and including a cathode being coupled in common.

30. The converter according to claim 29, further comprising an output capacitor being coupled to the cathodes of the diodes.

31. The converter according to claim 26, further comprising an input capacitor being coupled to one of the primary windings.

32. The converter according to claim 26, wherein the integrated magnetic structure further comprises at least three legs, each leg including a gap.

33. The converter according to claim 27, wherein the integrated magnetic structure further comprises an inductance being coupled to each of the at least two phases.

34. The converter according to claim 33, wherein the inductance is arranged to permit reduced current ripple in conjunction with interleaved operation.

35. The converter according to claim 34, wherein the integrated magnetic structure is arranged in conjunction with the paralleled output stage to permit a reduced inductance value for the inductance.

36. The converter according to claim 26, wherein the leg gaps are arranged to provide a reduced coupling between the primary and the secondary sides of the integrated magnetic structure such that each of the at least two phases can operate with a duty ratio greater than about 50%.

37. The converter according to claim 26, wherein the integrated magnetic structure leg gaps are arranged to obtain a relatively large leakage inductance between windings of the at least two phases.

38. The converter according to claim 26, wherein the integrated magnetic structure leg gaps are arranged to have an approximately equal dimension such that magnetic flux passing through each leg is approximately balanced.
